(19) United States
(12) Patent Application Publication
(10) Pub. No.: US 2018/0121628 A1
(43) Pub. Date: May 3, 2018

(54) METHOD OF DISTRIBUTION OF MEDICATIONS TO A PLURALITY OF PATIENTS

(71) Applicant: DISTRAIMED, Montastruc-La-Conseillere (FR)

(72) Inventors: Michel FOUBET, SAINT-JEAN (FR); Olivier FOUBET, BRESSOLS (FR); Gregory FOUBET, Toulouse (FR)

(21) Appl. No.: 15/794,186

(22) Filed: Oct. 26, 2017

(30) Foreign Application Priority Data
Oct. 28, 2016 (FR) 16.60546

(51) Int. Cl. G06F 19/00; G06Q 10/10

(52) U.S. Cl. CPC G06F 19/3456; G06Q 10/109

(57) ABSTRACT

Disclosed is a method of distribution of medications to a plurality of patients in which dose-time medication organisers are used, each containing, for a patient, different unitary doses of medications for a single dose time but for different days; the different medication organisers are grouped in a plurality of groups of dose-time medication organisers each including, in a common receiver, different medication organisers for different patients for a single dose time; for the distribution of medications, a receiver is selected for a dose time corresponding to the distribution time, and the medications are administered to the patients of the medication organisers of this receiver.

### BACKGROUND OF THE INVENTION

### Field of the Invention

The invention relates to a method of distribution of medications to a plurality of patients such as patients residing in the same establishment, in particular a medico-social establishment such as a retirement home, a home for handicapped persons, a rehabilitation or healthcare establishment (e.g. thalassotherapy), a sanatorium, a hospital, a clinic . . . .

### Description of the Related Art

Methods of distribution of medications to patients are already known in which single-use (disposable) medication organisers are used which enable the different medications to be packaged and grouped for each patient over a predetermined period of time, e.g. a week, according to a medical prescription. Each medication organiser is formed by a one-piece package comprising a plurality of packaging cells, each packaging cell containing a group, named unitary medication dose, of at least one medication intended to be administered to a single patient at a given time of the day, named dose time. Thus FR2913333 and FR2876024 describe a weekly medication organiser having twenty eight packaging cells spread over four columns of seven cells, each packaging cell of a single column corresponding to one of the dose times of the day (morning, midday, evening, bedtime), the different packaging cells of a single line corresponding to the different dose times of a single day of the week. Usage assumes that a single medication organiser must necessarily be specific to a single patient and can thus contain only the medications intended for a single patient.

In all the known methods of distribution of medications to a plurality of patients using such medication organisers at one time of day, named distribution time, a medication organiser corresponding to this patient is selected for the current period and the unitary dose of medications intended for this patient is given, being contained in the packaging cell of this medication organiser, of which the dose time corresponds to the time and day of distribution. In order to facilitate this distribution, the medication organisers are either hung up in the immediate proximity of the patients (e.g. on the patient's bed frame) or they are collected together in a nurse's room in which a nurse responsible for the distribution round to the different patients separates the different cells of the different unitary doses of the different patients, and places them in a tray which she uses during her round to distribute the unitary doses of medication to the different patients in turn, or they are transported in a distribution trolley.

These known distribution methods have a number of disadvantages.

Firstly, it is often the case that the prescription of certain patients of the plurality of patients concerned does not include the four daily dose times and/or does not include a unitary dose of medications for each day of the week. Consequently, for these patients the weekly medication organiser will include one (or more) unused, empty packaging cells. In some cases, e.g. in retirement homes, this situation may arise for the large majority of the patients. This leads in particular to considerable wastage of material and to unnecessary cost.

U.S. Pat. No. 8,123,036 describes a blister pack medication organiser, comprising a row of seven compartments, each row corresponding to a dose time for a patient and being provided with means for attachment to one or a plurality of juxtaposed rows permitting groups of blister packs to be formed for each patient in the case of a multiple daily prescription. Nevertheless, this device is complex and expensive to produce. It requires specific attachments to be made according to the medical prescriptions of each patient, which is relatively time-consuming and expensive in terms of labour. Furthermore, it is not free of risk in so far as different rows for different patients can be inadvertently attached to one another, leading to an error in the administration of medications to patients.

WO 99/61324 describes an apparatus for automatic distribution of medical articles in reusable individual bin receptacles, each bin receptacle comprising at least one individual sector. These bin receptacles can be bins associated with each patient in a hospital and are thus filled by a robot dispenser immediately before each dose time of each day with pre-packaged medications in overjacketed packages each containing one dose of a medication. One sector of each bin contains the medications to be administered to a patient for a normal dose time of the day. The other sectors can be used to administer medications to the patients between the normal dose times. For the distribution of the medications to the different patients, the nurse uses a mobile trolley containing a bin for each patient. The use of such bins which are over-sized with respect to the actual distribution needs at the normal dose times leads to a high degree of complexity and costs which would be best avoided. Furthermore, the trolley used for the distribution containing a bin for each patient, including patients for whom no distribution of medications is to take place, is a source of errors.

WO 2015/148375 describes a secure transportation module for medications containing one or a plurality of doses of one or a plurality of medications for a single patient. This module is used by the pharmacist to prepare the doses intended for a patient, then is used at the medication administration site by being loaded onto a mobile distribution trolley. The use of such transportation modules containing a single unitary dose of medications for a patient necessitates individual processing of each unitary dose with respect to the filling of the module, its transportation to the distribution site and its use for the distribution, and is particularly expensive.

### SUMMARY OF THE INVENTION

The invention thus aims to overcome these disadvantages.

It thus aims in particular to propose a method of distribution of medications to a plurality of patients, which is more economical, avoids the wastage of single-use packaging and does not necessitate time-consuming handling which is expensive in terms of labour and can lead to errors in the administration of medications to patients.

More particularly it aims to propose a distribution method which is simple, rapid, totally reliable and, by design, limits the amount of single-use packages to that strictly necessary to the different patients.

It also aims to propose such a distribution method which is compatible with the habits of care personnel responsible for the distribution of medications to the patients in the establishments, and with the constraints and regulations in force in these establishments and/or for the distribution of medications.

In order to do this, the invention relates to a method of distribution of medications to a plurality of patients, in which, for each patient of said plurality of patients, medications intended for this patient being packaged in at least one one-piece package, named medication organiser, comprising a plurality of packaging cells, each packaging cell containing a group, named unitary dose of medications, of at least one medication intended to be administered to this patient at a given time of the day, named dose time:
for the distribution of a unitary dose of medications to one patient of said plurality of patients, a medication organiser corresponding to this patient is selected and the unitary dose of medications intended for this patient and contained in a packaging cell of this medication organiser is administered,
   characterised in that:
medication organisers, named dose-time medication organisers, are used, each containing, for one patient of said plurality of patients, different unitary doses of medications for a single dose time but for different days, each packaging cell of a dose-time medication organiser containing a unitary dose of medications for this single dose time for this patient,
the different dose-time medication organisers of said plurality of patients are grouped into a plurality of groups of dose-time medication organisers, each group of dose-time medication organisers comprising, in a common receiver, different dose-time medication organisers for different patients of said plurality of patients, all the dose-time medication organisers of a single group of dose-time medication organisers all corresponding to a single dose time,
for the distribution of medications to patients of said plurality of patients at one time of one day, named distribution time, a receiver containing a group of dose-time medication organisers for a dose time corresponding to the distribution time and to these patients is selected, and the unitary doses of medications are administered to these different patients using the dose-time medication organisers of this receiver.

In order to facilitate the distribution and/or to enhance the security thereof, in an advantageous manner and in accordance with the invention, dose-time medication organisers each provided with means for identification of the dose time of this dose-time medication organiser are used. In certain possible embodiments, it is each packaging cell of a dose-time medication organiser which bears such means for identification of the dose time of this dose-time medication organiser.

For example, in certain advantageous embodiments in accordance with the invention, said means for identification of the dose time comprise at least one code for reading in a contactless manner—in particular for optical or RFID reading. In these embodiments, in an advantageous manner, a method in accordance with the invention is also characterised in that during the distribution of a unitary dose of medications to a patient, a computing device provided with at least one code reader for contactless reading is used, and the code for contactless reading identifying the dose time of the dose-time medication organiser of the patient is read with the aid of such a reader, and in that the computing device is adapted to compare the dose time identified by the code thus read and to emit an alarm signal if this dose time does not correspond to the present time, i.e. to the distribution time. Thus, the correspondence between the distribution time and the dose time of each dose-time medication organiser is verified and validated during distribution to each patient.

In a similar way, in order to facilitate the distribution and/or to enhance the security thereof, in an advantageous manner and in accordance with the invention, dose-time medication organisers each provided with means for identification of the patient corresponding to this dose-time medication organiser are used. In certain possible embodiments, it is each packaging cell of a dose-time medication organiser which bears such means for identification of the patient.

For example, in certain advantageous embodiments in accordance with the invention, said means for identification of the patient comprise at least one code for reading in a contactless manner—in particular for optical reading and/or an RFID circuit. In these embodiments, a method in accordance with the invention is advantageously also characterised in that a code for contactless reading of individual identification of each patient is associated with each patient, in that during distribution of a unitary dose of medications to a patient a computing device provided with at least one code reader for contactless reading is used, the code for contactless reading of identification associated with the patient is read with the aid of such a reader, the code for contactless reading of identification of the patient borne by the dose-time medication organiser is read with the aid of such a reader, and in that said computing device is adapted to compare the codes thus read and to emit an alarm signal if there is a difference.

There is nothing to prevent provision being made that at least one receiver contains a plurality of groups of medication organisers respectively corresponding to different dose times. Nevertheless, preferably, advantageously and in accordance with the invention, each receiver contains a single group of dose-time medication organisers. In other words, all the medication organisers of a single receiver all correspond to a single dose time. Thus for a dose time corresponding to the distribution time, a receiver corresponding to this dose time and containing only medication organisers for this dose time is selected. In this way, the handling of the groups of dose-time medication organisers is facilitated and made more reliable, and the security of the distribution of the medications is improved all the more.

Moreover, in some possible embodiments of the invention, receivers are used which are each provided with means for identification of each dose time of the medication organisers grouped in this receiver. These identification means can comprise at least one code for contactless reading, in particular for optical reading and/or an RFID circuit. As a variation or in combination, colour codes can be used to identify at first sight each dose time associated with a receiver.

Whatever the case may be, in a method in accordance with the invention, means for identification of the dose time of each dose-time medication organiser are affixed to each dose-time medication organiser and/or to each packaging cell of each dose-time medication organiser and/or to each receiver containing dose-time medication organisers corresponding to this dose time.

Furthermore, advantageously and in accordance with the invention, for the distribution of medications at a distribution time, said receiver is transported in turn to the different patients for whom said receiver contains a dose-time medication organiser. In other words, a distribution round to the different patients is carried out for each distribution time using a receiver containing dose-time medication organisers for these different patients, the dose time of the different medication organisers of the receiver corresponding to the distribution time.

For example, in some embodiments of a distribution method in accordance with the invention, said receiver is transported on a trolley provided with a computing device, said receiver and the computing device being adapted to cooperate with each other in order to permit identification in said receiver of a dose-time medication organiser to be used for a patient and the recording in a memory of the distribution of a unitary dose of medications to a patient from a dose-time medication organiser of the receiver.

Moreover, in a method in accordance with the invention, the different dose-time medication organisers of said plurality of patients can be grouped in receivers even during production of the medication organisers at a medication organiser-producing site (pharmacy) and/or after transportation thereof in an establishment. Whatever the case may be, advantageously and in accordance with the invention, the receivers of the groups of dose-time medication organisers are stored in the proximity of said plurality of patients.

More particularly, advantageously and in accordance with the invention, since said plurality of patients reside in a single establishment, the receivers of the groups of dose-time medication organisers are stored in this establishment. According to the fixed infrastructures of this establishment and said plurality of patients included in a single distribution method in accordance with the invention, different variations can be envisaged. For example, when the patients are grouped by floors in a building it is possible to provide a storage location for the different receivers for each floor. Other variations are possible (storage of the receivers by corridor, by building, by department, by sector . . . ).

In a distribution method in accordance with the invention, there is nothing in principle to prevent the use of reusable medication organisers. Nevertheless, advantageously and in accordance with the invention, single-use medication organisers are used. In particular, advantageously and in accordance with the invention, since each packaging cell of a dose-time medication organiser is adapted to be able to be separated individually from the other packaging cells of the dose-time medication organiser, for the distribution of a unitary dose of medications to a patient, a packaging cell is separated from the dose-time medication organiser of this patient contained in said receiver.

For example, dose-time medication organisers are used, each being formed of a blister pack comprising a row of wells with removable covers (e.g. in the form of labels), each well forming a packaging cell of the dose-time medication organiser.

The invention relates more particularly to such a method for the distribution of medications in the form of a galenic solid—in particular one which is non-integrally pulverulent, preferably non-pulverulent—such as medications of the reconditionable Per os type, e.g. tablets, cachets, hard gelatin capsules, capsules, pills, pastilles, sugar-coated tablets . . . . However, it also extends to a method of distribution of medications able to be of a different galenic form (e.g. at least some of the medications being in liquid form, e.g. drops, ampoules, . . . ).

Thus, while the medication organisers are packages grouping medications of a plurality of unitary doses of medications of a single patient, and have thus traditionally been systematically used individually for each patient separately from the other medication organisers intended for other patients, the inventor has determined for the first time that it is in reality possible and of considerable advantage to group dose-time medication organisers for different patients in receivers, each receiver corresponding to a dose time, and to use such dose-time receivers for each distribution of the medications. In fact, this means that the use of medication organisers in which some packaging cells remain empty is avoided and that only the quantity of medication organisers and of packaging cells strictly necessary for the different patients is used, each receiver for a dose time not comprising a medication organiser for each patient who does not have a prescription for this dose time. It also means that the security of the distribution is ensured, a patient for whom there is no medication organiser in a receiver for a dose time is not able to receive a distribution of medications inadvertently for a distribution time corresponding to this dose time. It should also be noted that a method in accordance with the invention remains perfectly compatible with the habits of the personnel in this technical field, and this is equally the case with respect to the production of the medication organisers during packaging of the medications by pharmacists and with respect to the distribution of the different medications using medication organisers, in particular low-cost, single-use medication organisers.

The invention also relates to a method of distribution of medications to a plurality of patients characterised in combination by all or some of the features mentioned above or below.

### BRIEF DESCRIPTION OF THE DRAWINGS

Other aims, features and advantages of the invention will become apparent upon reading the following description given by way of non-limiting example and which makes reference to the attached figures in which:

FIG. 1 is an operating diagram of one embodiment of a set of devices permitting implementation of a distribution method in accordance with the invention,

FIG. 2 is a diagram illustrating the distribution of a unitary dose of medications to a patient in a distribution method in accordance with the invention,

FIG. 3 is a logic diagram showing an example of an embodiment of a distribution method in accordance with the invention.

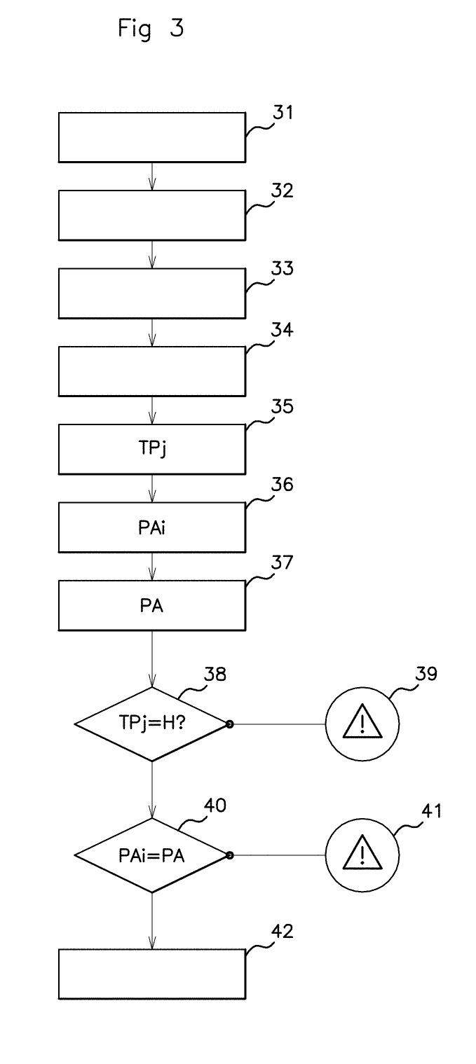

### DESCRIPTION OF THE PREFERRED EMBODIMENTS

In the illustrated example, the devices permitting implementation of a distribution method in accordance with the invention comprise a first device 11 for preparation of medication organisers at a first site, which is e.g. a pharmacy, according to the medical prescriptions of different patients; and a second device 12 for the distribution of medications to a plurality of patients located at a second site, which is e.g. an establishment in which the patients reside.

The first and second sites can be spaced apart from one another as illustrated, the medication organisers 18 prepared at the first site thus being transported, e.g. by vehicles 13, to the second site. However, there is naturally nothing to prevent the two sites being located in the immediate proximity of one another or even constituting a single site, the medication organisers being prepared in the establishment housing the patients.

At the first site, during a first step 31 of a method in accordance with the invention, a pharmacist 14 prepares medication organisers 18 from medical prescriptions and boxes 15 of medications, e.g. with the aid of a device providing assistance in the preparation of medication organisers as described e.g. in FR2942132, connected to a computing device 21 making it possible on the one hand to display the medical prescriptions on a screen 16 visible to the pharmacist and on the other hand to record in a database 17 information relating to the different medication organisers prepared, the different medications used and the different patients. This database 17 thus makes it possible to ensure the traceability of the operations carried out by the pharmacist 14.

The recording of information in the database 17 by the pharmacist 14 can be carried out in particular using a code reader 19 for contactless reading (e.g. an optical reader of optical codes such as bar codes, or a radio frequency code reader (RFID)) which the pharmacist 14 uses to read codes for contactless reading affixed to the boxes 15 of medications and codes for contactless reading printed on self-adhesive covers used to close the medication organisers 18, covers which are printed by a printer 20 of the computing device 21 after each medication organiser 18 has been filled.

In a method in accordance with the invention, dose-time medication organisers 18 are used which each contain, for a single specific patient, different unitary doses of medications for a single dose time, i.e. which are intended to be administered to this patient at a single given time of the day (e.g. morning, midday, evening, bedtime; or some other time), the different unitary doses of medications contained in the different packaging cells 23 of this dose-time medication organiser corresponding to different days of a reference period of several days of each medication organiser.

The dose-time medication organisers 18 can be weekly medication organisers comprising seven packaging cells 23 corresponding to the seven days of the week, each packaging cell 23 containing a unitary dose of medications for the patient and for this dose time. The dose-time medication organisers 18 can also be semi-monthly medication organisers or monthly medication organisers or bimonthly medication organisers or quarterly medication organisers, or of some other type, e.g. medication organisers for specific dates.

The dose-time medication organisers 18 are preferably single-use medication organisers (i.e. they can be thrown away after use), e.g. in the form of transparent blister packs. Each packaging cell 23 of a medication organiser 18 can be formed of a transparent blister pack dimple closed by a removable seal formed by the printed self-adhesive cover, and may or may not be separable from the other packaging cells of the medication organiser. It may or may not be compartmentalised in order to keep the different medications of a single unitary dose of medications separate from one another.

Each packaging cell 23 of a dose-time medication organiser 18 advantageously has at least one code 46 for contactless reading (code for optical reading such as a bar code and/or an RFID circuit) identifying, in the database 17, the patient, the dose time of the medication organiser 18 and the day (of the week (Monday, Tuesday, Wednesday, Thursday, Friday, Saturday or Sunday) or of the month (the date) or of some other period) of administration of the unitary dose of medications of this packaging cell 23. The same code for contactless reading can be used to identify all of these different items of information, or different codes for contactless reading can be used to identify respectively these different items of information.

In some embodiments, all the dose-time medication organisers 18 are identical and in particular have the same number of packaging cells 23. Consequently, it may arise that some packaging cells of a medication organiser for one particular patient are not filled if this patient does not have to receive a unitary dose of medications every day of the reference period corresponding to the dose-time medication organisers 18.

However, in contrast, there is nothing to prevent provision alternatively being made for each dose-time medication organiser 18 to have a number of packaging cells 23 corresponding exactly to the number of different days of the reference period on which the patient must receive a unitary dose of medications, e.g. if the reference period corresponds to the total treatment period of the patient. In this variation, all the packaging cells 23 of a single dose-time medication organiser 18 are necessarily filled.

It should also be noted that colour codes can be used to identify at first sight a dose time of a dose-time medication organiser 18 and/or a day of administration of the unitary dose of medications of a packaging cell of a dose-time medication organiser 18.

The pharmacist 14 preferably simultaneously or successively prepares the different dose-time medication organisers 18 required for a single patient for the different dose times of the reference period of the medication organisers before preparing the different medication organisers intended for another patient.

After the preparation of each medication organiser 18, during the subsequent step 32 the pharmacist 14 places the prepared dose-time medication organiser 18 in a receiver 22 corresponding to this dose time, i.e. permitting the different dose-time medication organisers 18 to be grouped, all corresponding to a single dose time and being intended for different patients of a plurality of patients for whom a single distribution round can be carried out within an establishment.

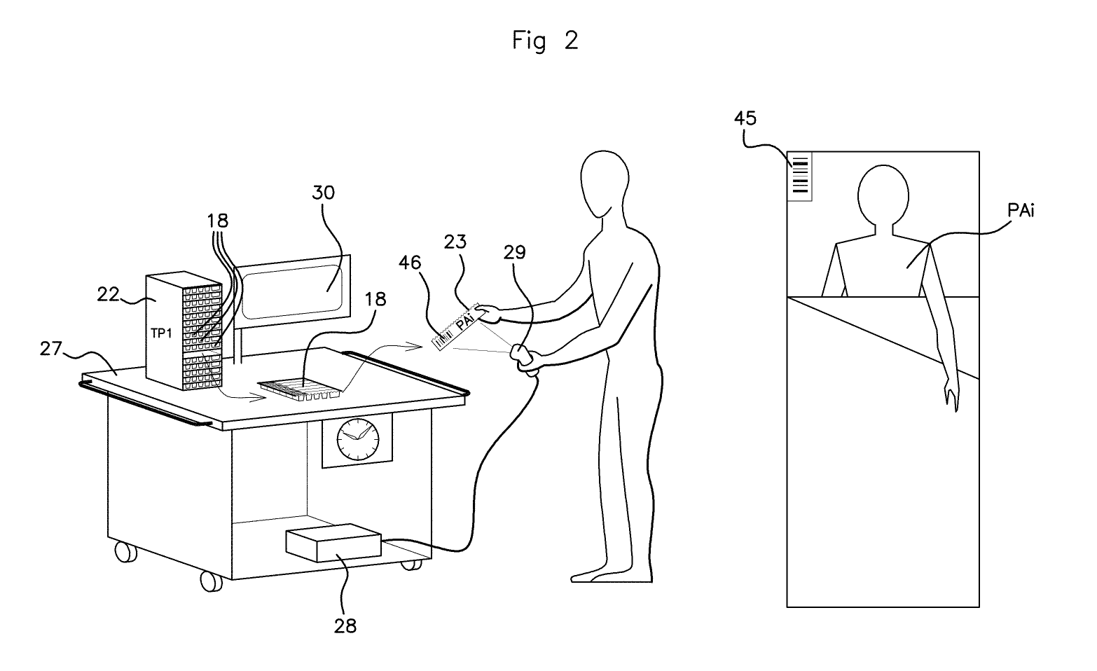

In the example, four dose-time TPj receivers 22 are shown, j varying from 1 to 4: a first receiver 22 corresponding to a first dose time TP1 (e.g. morning); a second receiver 22 corresponding to a second dose time TP2 (e.g. midday); a third receiver 22 corresponding to a third dose time TP3 (e.g. evening); and a fourth receiver 22 corresponding to a fourth dose time TP4 (e.g. bedtime). Each receiver 22 is advantageously formed of a box as shown in FIG. 2 comprising a plurality of blister pack-receiving levels, each level being formed of opposing grooves permitting a blister pack constituting a medication organiser 18 to be received between them. Each receiver 22 thus makes it possible to group Nj different dose time medication organisers 18 PPA1, PPA2 . . . , PPAi, . . . , PPANj for Nj differents patients PA1, PA2 . . . , PAi, . . . , PANj for the dose time TPj during preparation thereof by the pharmacist 14. The number Nj of medication organisers contained in each receiver 22 can naturally vary from one receiver to the other, not all the patients necessarily having a dose of medications for all the dose times TPj of the different receivers 22. As a maximum, each receiver 22 comprises a number Nj of medication organisers corresponding to the number N of patients of said plurality of patients for whom a single distribution round will be effected using the receivers 22.

In some advantageous embodiments, each receiver 22 has means for identification of each dose time corresponding to this receiver, e.g. in the form of a code for optical reading (e.g. a bar code) and/or an RFID circuit and/or a colour code permitting each dose time of the dose-time medication organisers contained in this receiver to be identified. In the embodiments in which each receiver 22 contains dose-time medication organisers 18 all corresponding to a single dose time, these identification means permit this single dose time to be identified. For example, the receivers 22 can simply be of different colours depending on the corresponding dose time. Nevertheless, in a method in accordance with the invention, each receiver 22 does not necessarily have a means for identification of each dose time of the medication organisers contained in this receiver.

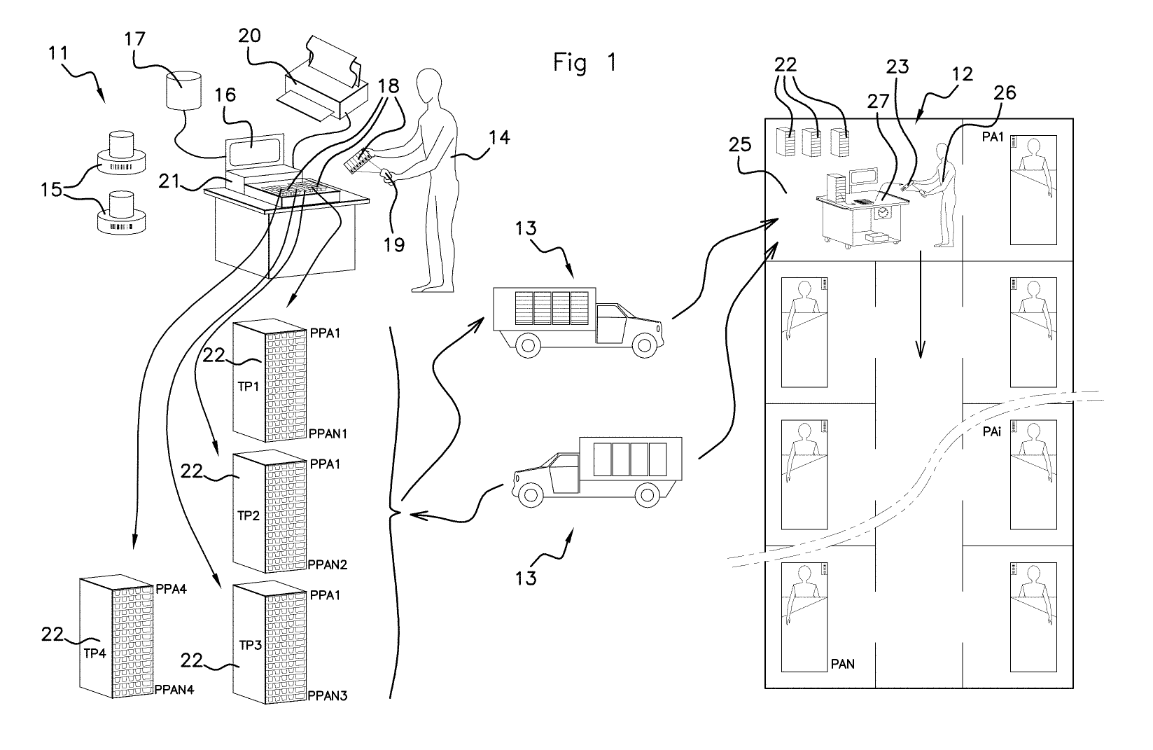

Once the dose-time medication organisers 18 have been thus prepared for each patient, then grouped in the dose-time receivers 22, these receivers 22 are transported during the transport step 33 towards the second site, e.g. with the aid of transportation vehicles 13 as shown schematically in FIG. 1.

In the illustrated example, the second site is a floor of a care establishment housing the N patients of said plurality of patients. On this floor, the different dose-time receivers 22 delivered by a vehicle 13 are stored during a storage step 34 in a room 25 which is e.g. a nurse's room. The dose-time receivers 22 which were present in the room 25 but have been emptied after the distribution of all the medications of the medication organisers which they contained to the different patients during a preceding period may possibly be recovered and transported back to the first site to be reused to store new medication organisers.

In order to carry out a distribution round of unitary doses of medications to the different patients at one time of day, named distribution time H, a nurse 26 uses a trolley 27 permitting transportation of a receiver 22 and being provided with a computing device 28 comprising in particular a code reader 29 for contactless reading and a man-machine interface 30 comprising in particular a screen and/or loudspeaker and/or a keypad.

During step 35, the nurse 26 selects the receiver 22 containing a group of dose-time TPj medication organisers 18 for a dose time corresponding to the distribution time H and places it on the trolley 27 which she then moves near to each patient in turn in order to administer thereto the unitary dose of medications corresponding to this dose time.

When she arrives with the trolley 27 near to a patient PAi, the nurse 26 uses the reader 29 during step 36 to read a code 45 for identification of the patient, borne by this patient. The computing device then displays on the screen the identification of this patient and the prescription corresponding to the unitary dose of medications for the dose time corresponding to the distribution time H. In one variation, it is possible for the computing device 28 to be adapted to display the list of patients, which are identified by their civil status and/or room number and/or a photograph, for whom medications have been prescribed and must be distributed for this dose time.

The nurse 26 then selects in the receiver 22 the medication organiser 18 corresponding to this patient PAi, and then uses the reader 29 again during step 37 to read each code 46 for contactless reading borne by the packaging cell 23 of the medication organiser 18 contained in the receiver 22 and intended for this patient.

During a test 38, the computing device 28 determines firstly whether or not the dose time TPj of the dose-time medication organiser 18 selected by the nurse as determined by a code 46 for contactless reading thus read on the packaging cell 23 of the medication organiser 18 corresponds to the distribution time H and to the current date as determined by an internal clock of the computing device 28. For example, the dose time TPj corresponds to the distribution time H if this distribution time H is between two extreme hours of the day defining this dose time. For example, for the dose time TP1 corresponding to the morning, the distribution time H must be between 6 o'clock in the morning and 11 am. The dose time also corresponds to the current date if the day of the reference period of the packaging cell 23 determined by the code 46 for contactless reading is identical to that of the current date.

If it does not correspond, an alarm signal is emitted by the computing device 28 during step 39, e.g. on the screen and/or via the loudspeaker to warn the nurse 46 of an error. If it is identical, the computing device 28 then determines, during the test 40, whether or not the identification PAi of the patient specified by the code 45 for identification of the patient and borne by this patient and previously read corresponds to the identification PA of the patient as determined by a code 46 for contactless reading which is read on the medication organiser 18. If it does not correspond, an alarm signal is emitted by the computing device 28 during step 41, e.g. on the screen and/or via the loudspeaker to warn the nurse 46 of an error. If it does correspond, a validation signal for administration can be communicated to the nurse 46 by the computing device 28 (via the screen and/or the loudspeaker), then the nurse 46 detaches the packaging cell 23 from the medication organiser 18 and gives it to the patient during step 42 for administration of the unitary dose of medications to the patient. It should be noted that after this administration of the unitary dose of medications to the patients the dose-time medication organiser 18 of this patient generally also contains other packaging cells containing unitary doses of medications for the same dose time but for subsequent different days if the reference period of the dose-time medication organisers has not entirely elapsed, i.e. if the day of the current date is not the last day of the reference period.

The nurse then moves the trolley 27 near to the next patient and proceeds until a unitary dose of medications has been administered to all the patients for whom a medication organiser is present in the receiver 22.

The use of the computing device 28 for the distribution of the unitary doses of medications makes it possible to avoid any error in administration, any oversight or any doubling-up of the administration.

It goes without saying that this computing device 28 can be of greater or lesser degree of complexity and can even be used to assist the nurse in the selection of the medication organiser 18 corresponding to a patient, either because the location of the medication organiser in the receiver 22 has been recorded in the database 17 during preparation of the medication organisers 18 and receivers 22 and the computing device 28 also accesses this database 17 and indicates this location to the nurse on the screen, or because the receiver 22 is itself connected to the computing device 28 and provided with e.g. illumination means facilitating the identification of the medication organiser 18 to be used after reading the code 45 for identification of the patient by the reader 29.

The invention can cover numerous variant embodiments and various applications other than those described above and illustrated in the figures. The receivers 22 can have any other structure, may or may not be completely closed, be provided with a locking/unlocking device, possibly provided with mechanisms and/or automated means permitting them to be opened and/or unlocked. The medication organisers 18 can also have a structure other than a single-use transparent blister pack: they may be packages provided with a plurality of dimples with covers or of some other type. The distribution method in accordance with the invention can be used in various applications, not only within the framework of a single floor of an establishment but also e.g. in a building or in a plurality of adjoining buildings or even in a room in which the different patients are all housed. The codes 45 for identification of the patients are not necessarily borne by these patients but can be affixed to a bed of the patient or near to the door of a patient's room or another location. The codes for contactless reading can be optically read codes such as bar codes, or radio frequency-read codes or the like. The receivers 22 can be used with their opening vertical as shown or, in contrast, with their opening horizontal and facing upwards, possibly being grouped in drawers.

1. Method of distribution of medications to a plurality of patients, in which, for each patient of said plurality of patients, medications intended for this patient being packaged in at least one one-piece package, named medication organiser, comprising a plurality of packaging cells, each packaging cell containing a group, named unitary dose of medications, of at least one medication intended to be administered to this patient at a given time of the day, named dose time:
for the distribution of a unitary dose of medication to one patient of said plurality of patients, a medication organiser corresponding to this patient is selected and the unitary dose of medications intended for this patient and contained in a packaging cell of this medication organiser is administered, wherein
medication organisers, named dose-time medications organisers (18), are used, each containing, for one patient of said plurality of patients, different unitary doses of medications for a single dose time but for different days, each packaging cell (23) of a dose-time medication organiser (18) containing a unitary dose of medications for this single dose time for this patient,
the different dose-time medication organisers (18) of said plurality of patients are grouped into a plurality of groups of dose-time medication organisers, each group of dose-time medication organisers comprising, in a common receiver (22), different dose-time medication organisers (18) for different patients of said plurality of patients, all the dose-time medication organisers of a single group of dose-time medication organisers all corresponding to a single dose time,
for the distribution of medications to patients of said plurality of patients at one time of one day, named distribution time, a receiver (22) containing a group of dose-time medication organisers (18) for a dose time corresponding to the distribution time and to these patients is selected, and the unitary doses of medications are administered to these different patients using the dose-time medication organisers of this receiver (22).

2. Method according to claim 1, wherein dose-time medication organisers (18) each provided with means for identification of the dose time of this dose-time medication organiser are used.

3. Method according to claim 2, wherein said means for identification of the dose time comprise at least one code (46) for contactless reading.

4. Method according to claim 3, wherein during the distribution of a unitary dose of medications to a patient, a computing device (28) provided with at least one code reader (29) for contactless reading is used, and the code (46) for contactless reading identifying the dose time of the dose-time medication organiser (18) of the patient is read with the aid of such a reader (29), and wherein the computing device (28) is adapted to compare the dose time identified by the code thus read and to emit an alarm signal if this dose time does not correspond to the present time.

5. Method according to claim 1, wherein dose-time medication organisers (18) each provided with means for identification of the patient corresponding to this dose-time medication organiser are used.

6. Method according to claim 5, wherein said means for identification of the patient comprise at least one code (46) for contactless reading.

7. Method according to claim 6, wherein a code (45) for contactless reading of individual identification of each patient is associated with each patient, wherein during distribution of a unitary dose of medications to a patient a computing device (28) provided with at least one code reader (29) for contactless reading is used, the code (45) for contactless reading of identification associated with the patient is read with the aid of such a reader (29), the code (46) for contactless reading of identification of the patient borne by the dose-time medication organiser (18) is read with the aid of such a reader (29), and wherein said computing device (28) is adapted to compare the codes thus read and to emit an alarm signal if there is a difference.

8. Method according to claim 1, wherein each receiver (22) contains a single group of dose-time medication organisers (18).

9. Method according to claim 1, wherein for the distribution of medications said receiver (22) is transported in turn to different patients for whom said receiver (22) contains a dose-time medication organiser (18).

10. Method according to claim 9, wherein said receiver (22) is transported on a trolley (27) provided with a computing device (28), said receiver (22) and the computing device (28) being adapted to cooperate with each other in order to permit identification in said receiver of a dose-time medication organiser (18) to be used for a patient and the recording in a memory of the distribution of a unitary dose of medications to a patient from a dose-time medication organiser (18) of the receiver.

11. Method according to claim 1, wherein the receivers (22) of the groups of dose-time medication organisers are stored in the proximity of said plurality of patients.

12. Method according to claim 1, wherein since said plurality of patients reside in a single establishment, the receivers (22) of the groups of dose-time medication organisers are stored in this establishment.

13. Method according to claim 1, wherein since each packaging cell (23) of a dose-time medication organiser is adapted to be able to be separated individually from the other packaging cells (23) of the dose-time medication organiser (18), for the distribution of a unitary dose of medications to a patient, a packaging cell (23) is separated from the dose-time medication organiser of this patient contained in said receiver (22).

14. Method according to claim 1, wherein dose-time medication organisers (18) are used, each being formed of a blister pack comprising a row of wells with removable covers, each well forming a packaging cell (23) of the dose-time medication organiser.

15. Method according to claim 1 for the distribution of medications in the form of a galenic solid.

16. Method according to claim 2, wherein dose-time medication organisers (18) each provided with means for identification of the patient corresponding to this dose-time medication organiser are used.

17. Method according to claim 3, wherein dose-time medication organisers (18) each provided with means for identification of the patient corresponding to this dose-time medication organiser are used.

18. Method according to claim 4, wherein dose-time medication organisers (18) each provided with means for identification of the patient corresponding to this dose-time medication organiser are used.

19. Method according to claim 2, wherein each receiver (22) contains a single group of dose-time medication organisers (18).

20. Method according to claim 3, wherein each receiver (22) contains a single group of dose-time medication organisers (18).
